(19) United States
(12) Patent Application Publication
(10) Pub. No.: US 2011/0029386 A1
(43) Pub. Date: Feb. 3, 2011

(54) ALLOCATION OF DIGITAL MEDIA STORE CREDIT FOR PRESENTATION OF AN ADVERTISEMENT WITH A MEDIA PLAYER

(76) Inventor: Derek Alton Devries, (US)

Correspondence Address: RICHARD R. PETERS, 26512 AVENIDA VERONICA, MISSION VIEJO, CA, 92691, US

(21) Appl. No.: 12/551,970

(22) Filed: Sep. 1, 2009

Related U.S. Application Data
(60) Provisional application No. 61/271,958, filed on Jul. 30, 2009.

(51) Int. Cl. G06Q 30/00

(52) U.S. Cl. 705/14.64

(57) ABSTRACT

Disclosed are a method, system and apparatus of an allocation of digital media store credit for presentation of an advertisement with a media player. In one aspect, an advertisement is provided to a media player. A media player is instructed to present the advertisement. A credit to an account associated with the media player is allocated if the media player presented the advertisement to a human user. The media player may present the advertisement according to a verification protocol. The verification protocol may be provided by the media server. The verification protocol may include a challenge-response test that ensures a response to the challenge-response test is generated by a human.

### CLAIM OF PRIORITY

This application claims priority to U.S. Provisional Patent Application titled “MEDIA SYSTEM”, No. 61/271,958 filed Jul. 30, 2009, is hereby incorporated by reference.

### FIELD OF TECHNOLOGY

This disclosure relates generally to media systems, and, more particularly, to allocation of digital media store credit for presentation of an advertisement with a media player.

### BACKGROUND

Advertisers pay providers of traditional media (e.g. television, radio and print media) to place or play an advertisement. The consumers of traditional media typically have no choice as when or how the advertisements were provided. For example, a television watcher watch advertisements temporally sequenced throughout a television program. The television program is not available through the television media without advertisements. This pattern holds true for the radio and print media as well. Recently, new devices (e.g. digital video recorders, mp3 players) and forms of media (e.g. video sharing websites, satellite radio) have become available that allow a consumer to filter out advertisements or provide media content without advertisements. Thus, advertisers may lose an audience and media providers may lose revenue.

Furthermore, consumer's use of the new devices and forms of media may not allow for the advertiser to review statistical or demographic information about the consumer and the consumer's behavior. Consequently, advertisers are not able to analyze consumer behavior. Additionally, the media providers are also less able to accumulate and analyze consumer behavior with the new devices and forms of media. Consumers may have an interest in providing behavior and interest information to the media providers and the advertisers. For example, due to the growing dearth of information, both providers and advertisers may not be able to provide media and advertising content of interest to the consumer.

### SUMMARY

The methods, apparatuses and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

In one aspect, an advertisement is provided to a media player. A media player is instructed to present the advertisement. A credit to an account associated with the media player is allocated if the media player presented the advertisement to a human user. The media player may present the advertisement according to a verification protocol. The verification protocol may be provided by the media server. The verification protocol may include a challenge-response test that ensures a response to the challenge-response test is generated by a human.

In another aspect, a system is provided for allocation of digital media store credit for play of an advertisement with a media player. A network interface enables communication with a computer network. A media server provides an advertisement to a media player via the computer network. The media server instructs a media player to present an advertisement on a graphical user interface of the media player. The media server allocates a credit to an account associated with the media player if the media server receives data verifying that the media player has presented the advertisement. A digital media store allows a trade of the credit for a media content. The media server may verify the media player presented the advertisement according to a verification protocol. The verification protocol may include a challenge-response test that ensures a response to the challenge-response test is generated by a human.

In yet another aspect, an article of manufacture is provided. The article of manufacture includes a set of application program interfaces embodied on a computer-readable medium for execution on a computer in conjunction with an advertisement application management module that identifies whether an advertisement has been played on a media player. The article of manufacture further includes a first interface that receives a media player identification and a set of advertisement play attributes for a specified period. The article of manufacture also includes a second interface that receives the media player identification and a set of verification protocol attributes for the specified period. Additionally, the article of manufacture includes a third interface that searches a database associated with a media server running the advertisement application management module for a match between the advertisement play attributes and the verification protocol attributes. The third interface may return a list of advertisement play attributes that match the verification protocol attributes. The article of manufacture may include a fourth interface to receive the list and return a credit value according to a number of matches populated in the list. The credit value may be provided to a user account that enables a user to acquire items at a digital media store.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic diagram of a media system, according to one embodiment.

FIG. 2 is a schematic representation of a media player, according to one embodiment.

FIG. 3 is a schematic diagram of a media server, according to one embodiment.

FIG. 4A is a flow chart illustrating verification and provision of a credit to a user's account with the advertisement application management module, according to one embodiment.

FIG. 4B is a continuation of the flow chart illustrating verification and provision of a credit to a user's account with the advertisement application management module, according to one embodiment.

Other features of the present embodiments will be apparent from the accompanying drawings and from the detailed description that follows.

### DETAILED DESCRIPTION

Disclosed are a several methods and an apparatus for allocation of digital media store credit for presentation of an advertisement with a media player. Although the present embodiments have been described with reference to specific example embodiments, it will be evident that various modifications and changes may be made to these embodiments without departing from the broader spirit and scope of the various embodiments.

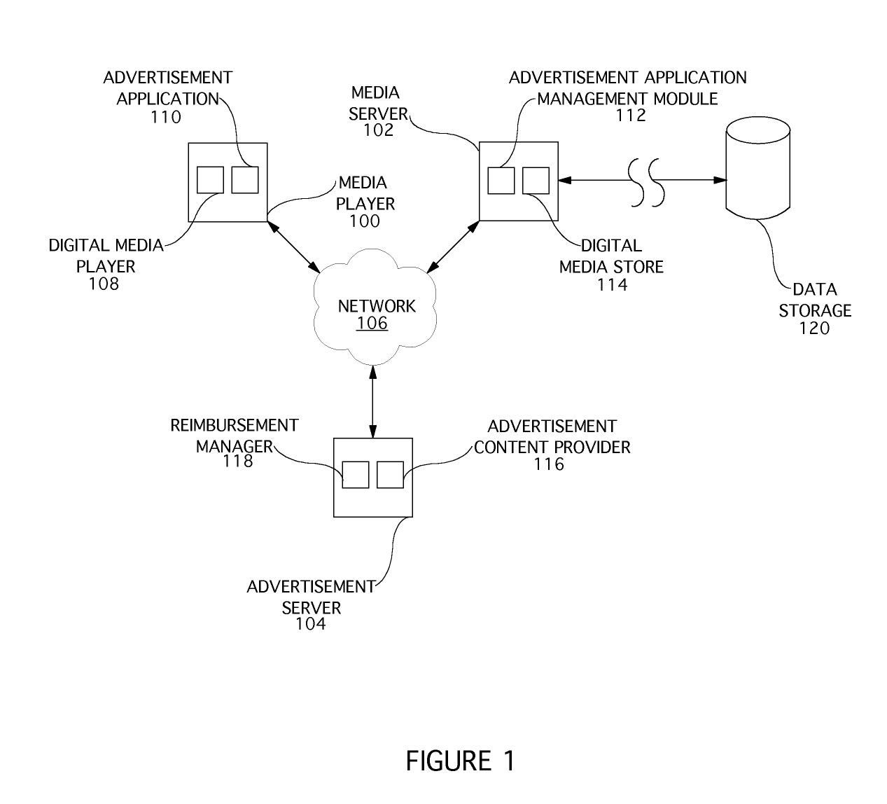

FIG. 1 illustrates a schematic diagram of a media system, according to one embodiment. The media system includes a media player 100 communicatively coupled to a media server 102 and an advertisement server 104 via a network 106.

The media player 100 includes a digital media player 108 and an advertisement application 110. The media player 100 is a computer capable of storing and playing digital media. The digital media is a media that uses electronics or electromechanical energy to store or transmit information to an audience. Example media players include, inter alia, a portable media player (e.g. a portable consumer electronic device that stores, organizes and plays audio, text and video files), a smart phones and a personal computer.

The media player 100 includes hardware systems and software functionalities to store, organize and play digital media files including multimedia files. In one embodiment, the digital media player 108 may be a software functionality that includes an application for playing multimedia files. For example, a user of the media player 100 may access a particular audio file stored in the media player and listen to the audio file using the digital media player 108.

The advertisement application 110 is an application for managing audio, text or video advertisements run on the digital media player 108. The advertisements may be downloaded via the network 106 from the media server 102. In one embodiment, the advertisement may also be downloaded from the advertisement server 104. In one embodiment, the advertisement application 110 causes the digital media player 108 to sequence an advertisement between discrete plays of two separate multimedia files. In one embodiment, the advertisement application 110 may insert various advertisements into an audio playlist or a video playlist. In one embodiment, the advertisement application 110 may interrupt the play of a particular media file to insert and play an advertisement. The play of the particular media file may then resume. The advertisement application 110 may include a set of instructions to determine a particular genre of a media file.

The advertisement application may then play a certain advertisement that has been associated by the advertisement server 104 or the media server 102 with the particular genre. For example, the media file may be a song by a particular artist. The media server may associate an advertisement for another album by the particular artist with the song. When digital media player 108 plays the song, the advertisement application 110 may then play the advertisement for the album after the song play has ended.

The advertisement application 110 may also monitor use of the of the media player 100 in order to determine whether the media player 100 presented the advertisement according to a verification protocol. The verification protocol is a system of procedures designed to ensure that the credit is provided to a user's account only when the user listens, read or watches an advertisement. For example, in one embodiment, the verification protocol may include a challenge-response test that ensures the response is generated by a human. The user may have a limited amount of time to correctly respond to the challenge-response test. The advertisement application 110 may increase the frequency rate of the challenge-response test as a period of playing media content with the media player increases. Media content may be stored as a media file in the memory of the media player 100. For example, the frequency of challenge-response tests may increase as a function of the time the digital media player 108 is run by the media player 100. Also, the frequency of challenge-response tests may increase if particular media content (e.g. a single song or video) is repeated a certain number of times in a row. In one embodiment, the challenge-response test may be a CAPTCHA. The CAPTCHA may be presented to the user to verify that the user is presently engaged with the advertisement currently presented by the digital media player 108. If a user fails to successfully pass a particular challenge-response test or other verification protocol, the user's account will not receive a credit for the played advertisement. Additionally, routine failure of challenge-response tests may invalidate a particular user's account.

Another example of a challenge-response test that may be used by the advertisement application 110 as a verification protocol includes facial recognition technology. In one embodiment, media player 100 may include or be coupled with a digital camera. The advertisement application 110 may cause the digital media player 108 to present a prompt to the user to place the user's face in front of the digital camera. The digital camera may then acquire a digital image of the user. The advertisement application 110 may then analyze the digital image of the user with a facial recognition algorithm to determine that the user is a human.

In various embodiments, other verification protocols may be used to ensure that a user does not gain the system and receive credit for advertisements that are not legitimately listened to, read or view by the user. Instructions regarding the verification protocol may be received by the advertisement application 110 from the media server 102.

The advertisement application 110 uploads information relating to the play of advertisements by the digital media player 108 to the media server 102 via the network 106. In one embodiment, the advertisement application 110 may also upload the information to the advertisement server 104 via the network 106. Both the media server 102 and the advertisement server 104 may utilize other verification protocols to analyze the information from the advertisement application 110 in order to determine the authenticity of the information.

The media server 102 may include an advertisement application management module 112. The advertisement application management module 112 manages the uploading of advertisements to the media player 100. The advertisement application management module 112 also manages the downloading of advertisements from the advertisement server 104. The advertisement application management module 112 verifies the validity of the verification protocol operations performed by the advertisement application 110. For example, the advertisement application management module 112 may implement a protocol to determine if the software of the advertisement application 110 has been tampered with by a third party.

The digital media store 114 is an online digital media store that provides digital media content to the media player 100. The digital media store 114 may include user account information. The user account may be associated with the media player 100 for purposes of acquiring credits to the user account. Credits held in a user account may be redeemed by the user for digital media content controlled by the digital media store 114. The user may also purchase digital media content from the digital media store 114. The digital media content is then stored in as a digital file in the media player 100. In one embodiment, when the user redeems a credit or purchases a digital media content, the digital media store presents the user with the option of also downloading one or more advertisements provided by the advertisement server. The user may then choose to download the advertisements into the media player 100. In one embodiment, the user may set the user's account to automatically acquire advertisements at a periodically interval. The user acquires credits to digital media content each time the user listens to, reads or watches an advertisement. In one embodiment, the user may also select particular genres or types of advertisements to download into the media player 100. In one embodiment, the advertisement application management module 112 analyzes the user's demographic data and the type of digital media content acquired by the user and uploads certain genres or types of advertisements according to the result. Other information including geographic information, past purchasing history, digital media content play history and social networking history may also be considered in the analysis.

In one embodiment, the advertisement application management module 112 may also collect demographic and digital media content statistical information from media players and users associated with the digital media store 114. This information may be passed on to the advertisement server 104 for analysis. The advertisement application management module 112 may also collect information from the media player 100 about the user's behavior when accessing media content. For example, the advertisement application management module 112 may collect information regarding how long a user watched a particular video or how many times a user listened to a certain song.

A data storage 120 may be communicatively coupled to the media server 102. The data storage 120 may be a component of a storage area network (SAN) or a network attached storage (NAS). The digital media content and the advertisements may be stored in the data storage 120.

The advertisement sever 104 is a server operated by an advertising entity. The advertising entity creates advertisements in a digital media format capable of being playing on the media player 100. The advertisement provider 116 provides the advertisements to the media server 102 via the network 106. The reimbursement manager 118 manages a reimbursement system whereby the proprietor of the digital media store 116 is redeemed for credits provided to the user. The advertising entity may use any demographic and digital media content statistical information provided by other entities of the system to create an advertisement.

It should also be noted that the media system of FIG. 1 provides both the entity operating the digital media store 114 and the advertising entity operating the advertisement provider 116 gain valuable information about the behavior and preferences of the user of the media player 100. In this way, the user may also consider her actions efficacious in determining the types of digital media content and advertisements available in the media system. The user is a part of a power feedback mechanism whose aggregate behavior partially defines the choices of the other entities.

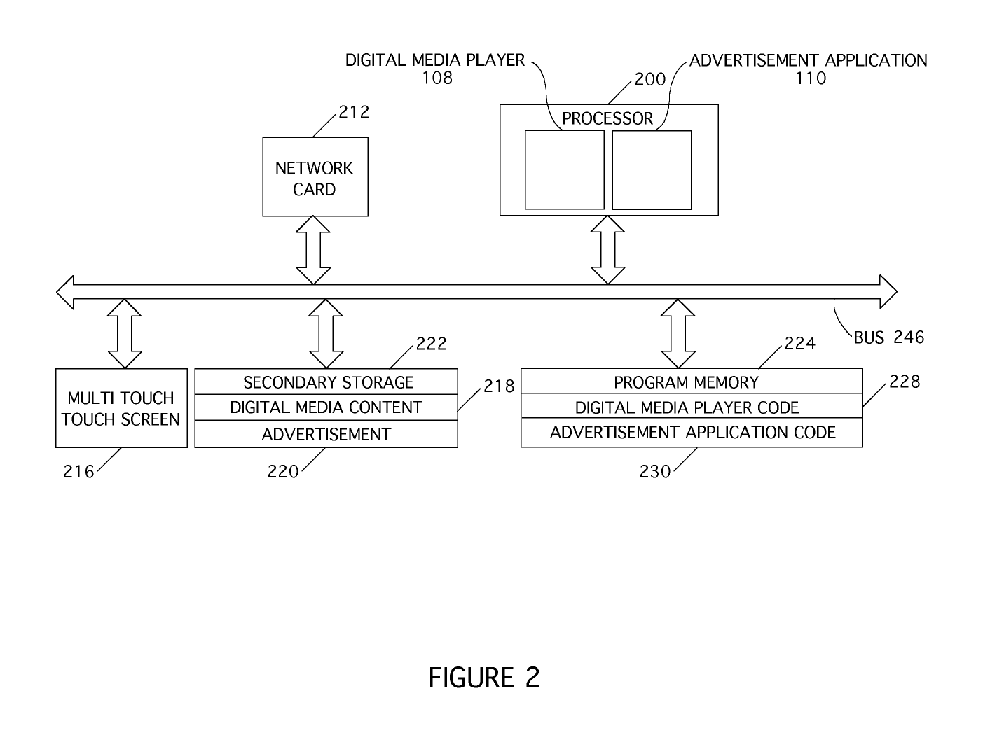

FIG. 2 is a schematic representation of a media player 100, according to one embodiment. FIG. 2 includes a representation of both the physical and code strictures of the media player 100. FIG. 2 includes a processor 200. The processor 200 is communicatively coupled to the other components of the media player 100 via the bus 240. The processor 200 is an electronic circuit that can execute computer programs. According to one embodiment, in active mode the processor 200 includes the digital media player 108 and the advertisement application 110. The digital media player 108 and the advertisement application 110 are shown as loaded into the processor 200 in order to perform their respective functions as described above. The source code for the digital media player 108 is located in the program memory 224 as the digital media player code 228. The source code for the advertisement application 110 is located in the program memory 224 as the advertisement application code 230. The program memory 224 may be a hard disk drive, flash driver or other memory device (either volatile or non-volatile).

The secondary storage 222 is a non-volatile data storage format (e.g. hard disk, flash memory). In one embodiment, the secondary storage 222 includes the data structures and files for the digital media content 218 and the advertisement 220. In one embodiment, the media player 100 may include a multi-touch screen 216. However, in other embodiments, the screen may any piece of electrical equipment that displays images generated by processor 200. The network card 212 enables the media player 100 to communicatively couple with the network 106.

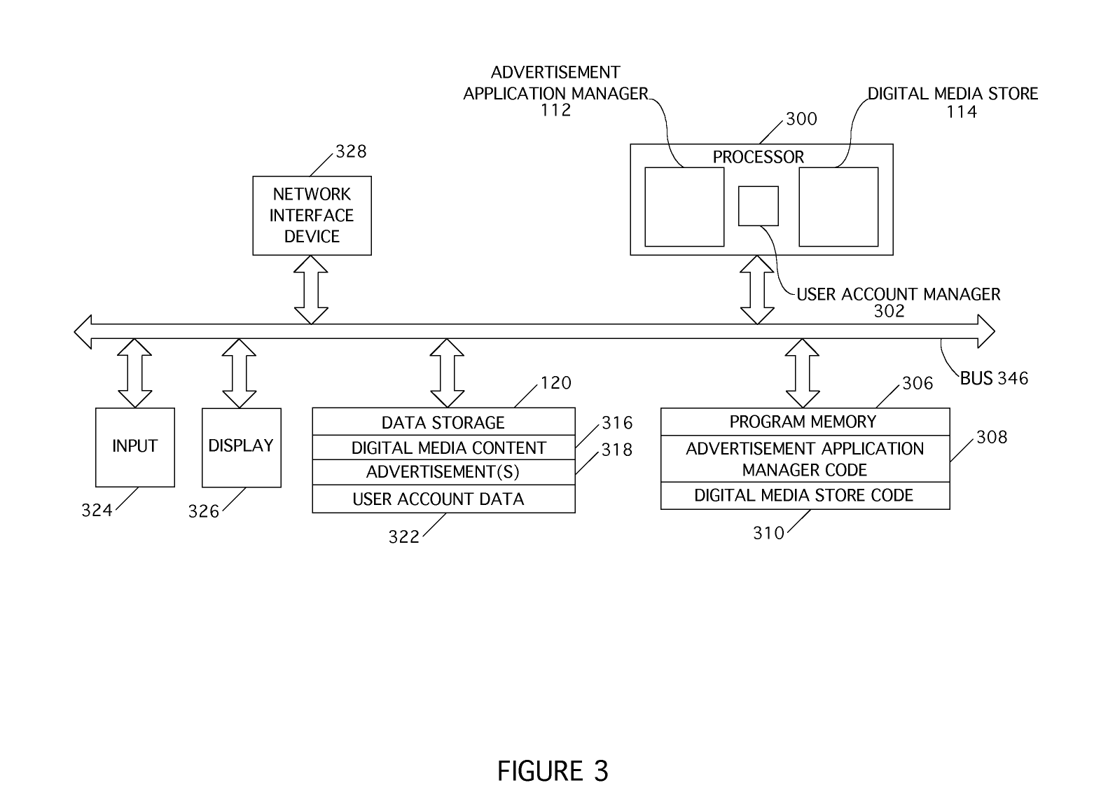

FIG. 3 is a schematic representation of the media server 102, according to one embodiment. FIG. 3 includes a representation of both the physical and code structures of the media player 100. FIG. 3 includes a processor 300. In one embodiment, in the active mode, the advertisement application manager 112, the user account manager 302 and the digital media store 114 are loaded into the processor 300 in order to perform their respective functions as described above. The source code for the advertisement application manager 112 is located in the program memory 306 as the advertisement application manager code 308. The source code for the digital media store 114 is located in the program memory 306 as the digital media store code 310. The program memory 306 may be a hard disk drive, flash driver or other memory device (either volatile or non-volatile).

The data storage 120 includes the data structures and files for the digital media content 316, the advertisement(s) 318 and the user account data 322. In one embodiment, the media server 102 includes an input 324 and an output 326. The network interface device 328 enables the media server 102 to communicatively couple with the network 106.

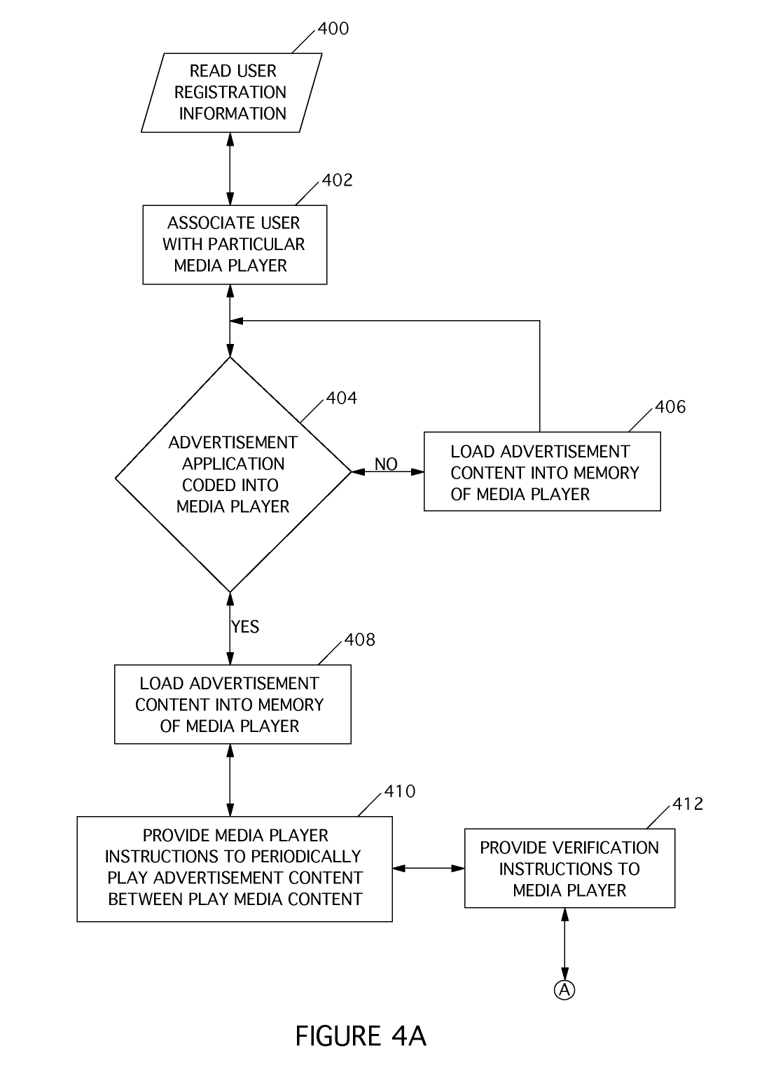

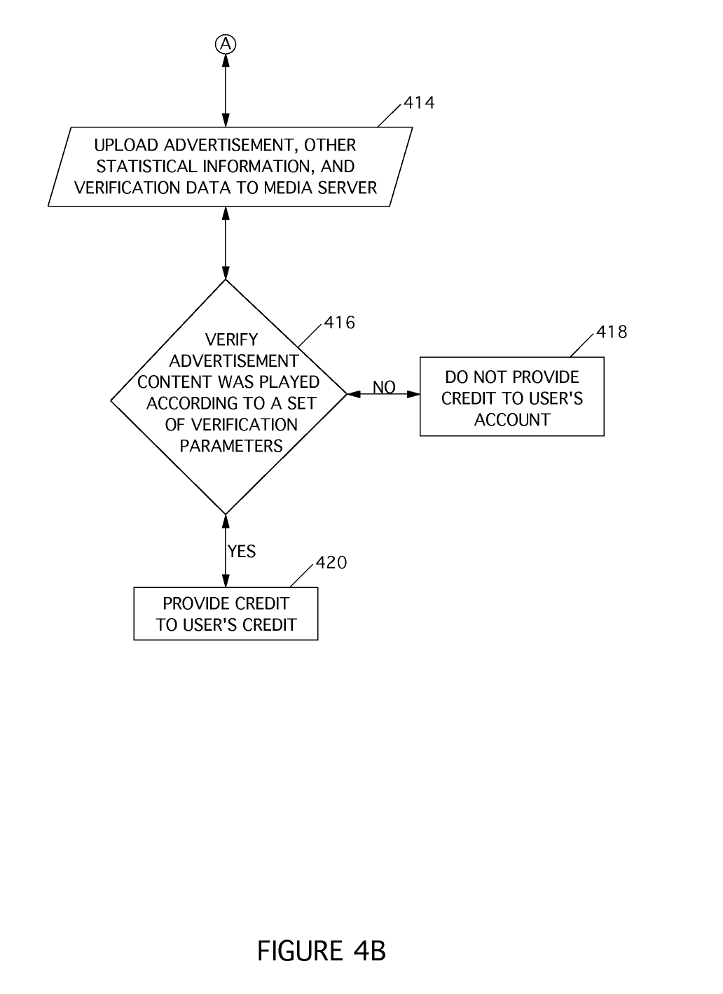

FIG. 4A is a flow chart illustrating verification and provision a credit to a user's account with the advertisement application management module 112, according to one embodiment. In operation 400 user registration information is read into the advertisement application management module 112. In operation 402, the user is associated with a particular media player (e.g. the media player 100). The registration information may be used to perform operation 402. In operation 404, a determination is made whether the advertisement application has been loaded into the media player 100. If the advertisement application has not been loaded into the media player 100, the advertisement application is loaded into the memory into the media player 100 in operation 406. In operation 408, an advertisement is loaded into the media player 100. In operation 410, instructions are provided into the media player to periodically play the advertisement between play of media content already extant in the media player 100. In operation 412, verification instructions are provided to the media player 100. In some embodiments, the verification instructions may be provided previously or contemporaneously to operation 408.

FIG. 4B is a continuation of the flow chart illustrating verification and provision a credit to a user's account with the advertisement application management module. In operation 414, the advertisement information and other statistical information are uploaded from the media player 100 into the media server 102 along with other verification data. In operation 416, the advertisement application management module 412 verifies the advertisement was played according to the verification parameters. In operation 418, credit is not provided to the user's account if the outcome of operation 416 is in the negative. In operation 420, credit is provided to the user's account if the outcome of operation 416 is positive.

In one example embodiment, the media player 100 may also collect data related to media application windows displayed with the media player's graphical user interface (GUI). For example, if two video application windows are simultaneously displayed on the GUI in an overlapping fashion, the media player 100 may collect data describing which video application window is on top of the other (i.e. is presented as a complete window covering a portion of another window). The media player 100 may time stamp this data. The media player 100 may then communicate this data to the advertisement application management module 112. The advertisement application management module 112 may then only provide a credit to the user's account if the advertisement screen was continuously dominant during the play of the advertisement.

In one example embodiment, the media server 100 may include a verification module that performs all the verification operations attributed to the advertisement application management module 112.

In one example embodiment, the media player 100 may maintain continuous access with the media server 102. The media server 100 may communicate verification data to the media server 100 in real-time via the network 106.

In one example embodiment, the media content displayed by the GUI may be text (e.g. an e-book, a downloaded article from a website). The advertisement may be present after a particular length of text or after a certain number of pages have been presented. For example, the text may be a three page newspaper article. After each page, after the user initiates a command to navigate to the next page, an advertisement may be presented with the digital media player 108 for a specified period of time. The next page may then be presented once the advertisement has been presented.

In one example embodiment, a set of application program interfaces (APIs) embodied on a computer-readable medium for execution on the media server 102 in conjunction with an advertisement application management module 112 that identifies whether an advertisement has been played on the media player 100. The set of APIs may include a first API may receive a media player 100 identification and a set of advertisement play attributes via the network 106. The set of API's may also include a second API that receives the media player identification and a set of verification protocol attributes for the specified period. The set of API's may also include a third API that searches a database (e.g. the data storage 120) communicatively coupled with the media server 102 running the advertisement application management module for a match between the advertisement play attributes and the verification protocol attributes. A user may receive credit if the advertisement play attributes and the verification protocol attributes match according to a pre-defined set of parameters.

An API may be an interface that defines the ways by which an application program may request services from libraries or operating systems. The API may include specifications for routines, data structures, object classes and protocols used to communicate between the requesting software and the library.

Although the present embodiments have been described with reference to specific example embodiments, it will be evident that various modifications and changes may be made to these embodiments without departing from the broader spirit and scope of the various embodiments. For example, the various devices, modules, etc. described herein may be enabled and operated using hardware circuitry (e.g., CMOS based logic circuitry), firmware, software or any combination of hardware, firmware, and software (e.g., embodied in a machine readable medium).

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method of a media server comprising:
providing an advertisement to a media player;
instructing the media player to present the advertisement; and
allocating a credit to an account associated with the media player if the media player presents the advertisement to a human user.

2. The method of claim 1 further comprising:
verifying the media player presented the advertisement according to a verification protocol.

3. The method of claim 2,
wherein the verification protocol comprises a challenge-response test that ensures a response a response to the challenge-response test is generated by a human.

4. The method of claim 3 further comprising:
instructing the media player to increase a frequency rate of the challenge-response test as a period of playing media content with the media player increases.

5. The method of claim 4, wherein the challenge-response test comprises presenting a CAPTCHA with a graphical user interface of the media player.

6. The method of claim 2, wherein the verification protocol comprises:
storing a first digital representation of a face.

7. The method of claim 6 further comprising:
instructing the media player to capture a second digital representation of the face if the media player within a specified period after the media player has played the advertisement;
comparing the first digital presentation of the face with the second digital representation of the face using a facial recognition system; and
verifying the media player played the advertisement according to the verification protocol if the facial recognition system determines the second digital representation of the face is sufficiently similar to the first digital representation of the user face.

8. The method of claim 2, wherein the credit allows an entity who controls the account associated with the media player to purchase media content from a digital media store.

9. The method of claim 8 further comprising:
causing a verification data to be communicated from the media player into a server hosting the digital media store.

10. The method of claim 8, wherein the verification data is invalidated if communicated to the server after a specified limit has lapsed.

11. The method of claim 1 further comprising a computer usable medium having a computer readable program code embodied therein, said computer readable program code adapted to be executed to implement the method of claim 1.

12. A system for allocation of digital media store credit for presentation of an advertisement with a media player:
a network interface to enable communication with a computer network;
a media server to provide an advertisement to a media player via the computer network, to instruct the media player to present the advertisement on a graphical user interface of the media player, and to allocate a credit to an account associated with the media player if the media server receives data verifying that the media player has presented the advertisement; and
a digital media store to allow a trade of the credit for a media content.

13. The system of claim 12, wherein the media server verifies the media player presented the advertisement according to a verification protocol.

14. The system of claim 13, wherein the verification protocol comprises a challenge-response test that ensures a response a response to the challenge-response test is generated by a human.

15. The system of claim 14, wherein the account associated with the user is not allocated a credit if the media server determines a violation of the verification protocol.

16. The system of claim 14, wherein the verification protocol comprises a rule that the data verifying the presentation of the advertisement is to be received by a specified time.

17. An article of manufacture comprising:
a set of application program interfaces embodied on a computer-readable medium for execution on a computer in conjunction with an advertisement application management module that identifies whether an advertisement has been played on a media player;
a first interface that receives a media player identification and a set of advertisement play attributes for a specified period;
a second interface that receives the media player identification and a set of verification protocol attributes for the specified period; and
a third interface that searches a database associated with a media server running the advertisement application management module for a match between the advertisement play attributes and the verification protocol attributes.

18. The article of manufacture of claim 17, wherein the third interface returns a list of advertisement play attributes that match the verification protocol attributes.

19. The article of manufacture of claim 18, further comprising a fourth interface that receives the list and returns a credit value according to a number of matches populated in the list.

20. The article of manufacture of claim 19, wherein the credit value is provided to a user account that enables a user to acquire items at a digital media store.
